(19) United States
(12) Patent Application Publication
(10) Pub. No.: US 2016/0266725 A1
(43) Pub. Date: Sep. 15, 2016

(54) Electronic Device Having Window System and Control Method Thereof

(71) Applicant: MStar Semiconductor, Inc., Hsinchu Hsien (TW)

(72) Inventor: Wei-Yang Hsu, Zhudong Township (TW)

(21) Appl. No.: 14/799,663

(22) Filed: Jul. 15, 2015

(30) Foreign Application Priority Data
Mar. 12, 2015 (TW) 104107927

(51) Int. Cl. G06F 3/0481

(52) U.S. Cl. CPC G06F 3/0481

(57) ABSTRACT

An electronic device having a window system and a control method thereof are provided. The electronic device includes a memory, a display controller and a screen. The control method includes following steps. A graphic layer is stored to the memory. The graphic layer includes a set of windows. According to the state of the set of windows of the graphic layer, the display controller is controlled to selectively obtain the graphic layer from the memory. When the graphic layer is obtained by the display controller, the graphic layer is displayed on the screen.

This application claims the benefit of Taiwan application Serial No. 104107927, filed Mar. 12, 2015, the subject matter of which is incorporated herein by reference.

### BACKGROUND OF THE INVENTION

1. Field of the Invention

The invention relates in general to an electronic device and a control method thereof, and more particularly to an electronic device having a window system and a control method thereof.

2. Description of the Related Art

With the development of technologies, electronic devices continue to innovate and progress. An electronic device having a window system provides one or multiple windows for a user to operate or for displaying information. For example, the window system may be a Microsoft Windows operating system, an Android operating system, or a Macintosh operating system. The window may be a user interface, a text input window, an information display window, or a desktop. The window provides various kinds of information and intuitive operation information. Thus, without having to memorize complicated text instructions, a user is allowed to directly perform operations on the window with ease of use.

### SUMMARY OF THE INVENTION

The invention is directed to an electronic device having a window system and a control method thereof. A transmission load of a memory is reduced through controlling a display controller.

According to an aspect of the present invention, a control method for an electronic device having a window system is provided. The electronic device includes a memory, a display controller and a screen. The control method includes following steps. A graphic layer is stored to the memory. The graphic layer includes a set of windows. According to the state of the set of windows, the display controller is controlled to selectively obtain the graphic layer from the memory. When the graphic layer is obtained by the display controller, the graphic layer is displayed on the screen.

According to another aspect of the present invention, an electronic device having a window system is provided. The electronic device having a window system includes a screen, a display controller, a memory and a central operating processor. The memory stores a graphic layer including a set of windows. The central operating processor controls the display controller to selectively obtain the graphic layer from the memory. When the display controller obtains the graphic layer, the graphic layer is displayed on the screen.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a schematic diagram of an electronic device having a window system;

FIG. 2 is a schematic diagram of windows, a graphic layer and screen;

FIG. 3 is a schematic diagram of another electronic device having a window system;

FIG. 4 is a flowchart of a control method for an electronic device having a window system;

FIG. 5 is a detailed flowchart of step S120 in FIG. 4;

FIG. 6 is another detailed flowchart of step S120 in FIG. 4;

FIG. 7 is another detailed flowchart of step S120 in FIG. 4;

FIG. 8 is a schematic diagram of another electronic device having a window system; and

FIG. 9 is another flowchart of a control method for an electronic device.

### DETAILED DESCRIPTION OF THE INVENTION

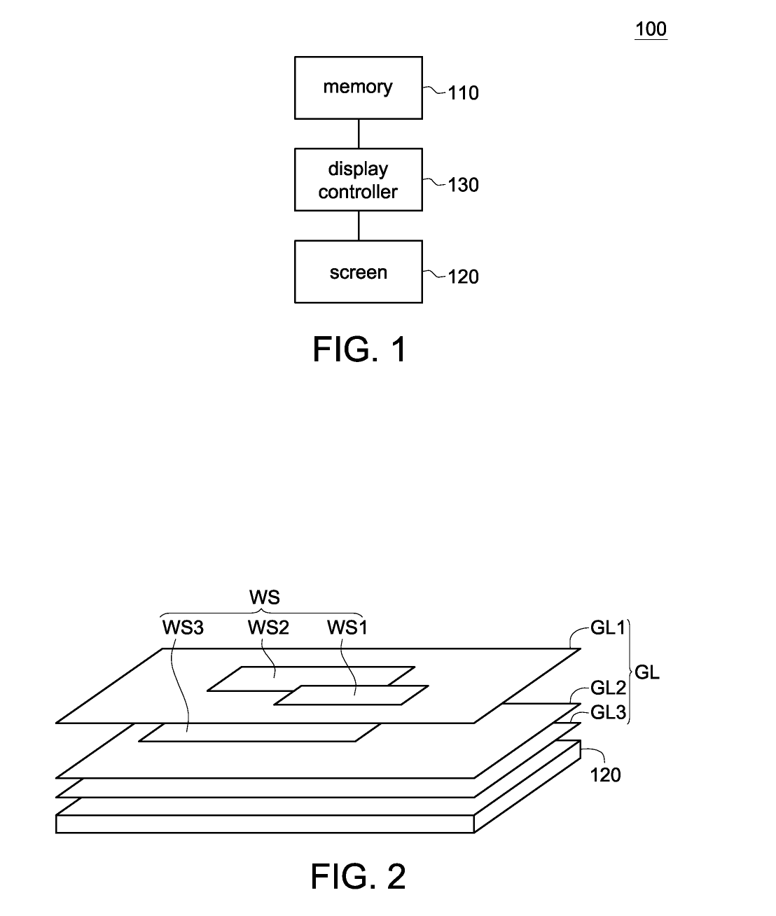

FIG. 1 shows a schematic diagram of an electronic device 100 having a window system. The electronic device 100 includes a memory 110, a screen 120 and a display controller 130. For example, the electronic device 100 is a smart television, a desktop computer, a laptop computer, a tablet computer or a smart phone. The window system provides one or multiple windows for user to operate or for displaying information. For example, the window system is a Microsoft Windows operating system, an Android operating system, or a Macintosh operating system.

FIG. 2 shows a schematic diagram of windows WS, graphic layers GL and the screen 120. For example, a window WS may be a user interface, a text input window, an information display window, an image, or a desktop. A graphic layer GL corresponds to a predetermined set of windows WS, and a set of windows WS may include one or multiple windows WS. For example, as shown in FIG. 2, among the graphic layers GL1, GL2 and GL3, the uppermost graphic layer GL1 corresponds to two windows WS1 and WS2, and the second last graphic layer GL2 corresponds to only one window WS3. In FIG. 2, the electronic device 100 has multiple graphic layers GL. In another embodiment, the electronic device 100 may have only one graphic layer, which corresponds to all windows WS of the electronic device 100. When the electronic device 100 has multiple graphic layers GL, an image that the screen 120 displays is a superimposed image of these graphic layers GL. When one of the graphic layers GL that a user wishes to view is displayed, the transparency of the other graphic layers GL may be set to 0, so as to cause the superimposed image only presents the graphic layer GL that the user wishes to view.

In one example, a graphic layer GL corresponds to a set of windows WS. One window WS may be a user interface of an application program, or a message frame. When an application program or message frame is opened, the corresponding window WS is opened and therefore exists on the graphic layer GL. The window WS existing on this graphic layer GL is superimposed by a graphic engine to form the graphic layer GL. The window WS existing on this graphic layer GL could be minimized to be temporarily hidden. When the window WS is hidden, its location information and patterns therein are recorded. Thus, when the window WS is restored, this window WS may be quickly superimposed back to its original position.

The memory 110 stores various kinds of data. For example, the memory 110 is a dynamic random access memory (DRAM). The above graphic layer GL may be temporarily stored in the memory 110. The screen 120 displays various kinds of data. For example, the screen 120 is a liquid crystal display (LCD) screen, an electronic paper, or a light emitting diode (LED) board. The display controller 130 may obtain the graphic layer GL from the memory 110, so as to display this graphic layer GL on the screen 120. For example, the display controller 130 is a chip, a circuit board, or a storage medium storing multiple sets of codes.

As described above, when only one graphic layer GL needs to be displayed on the screen, the transparency of the other graphic layers GL may be set to zero, so that the superimposed image accordingly represents only the graphic layer GL needing to be displayed on the screen. However, the other graphic layers GL having the transparency set to zero are still transmitted to the display controller 130, and occupy the transmission bandwidth between the memory 110 and the display controller 130, leading to a lowered transmission speed.

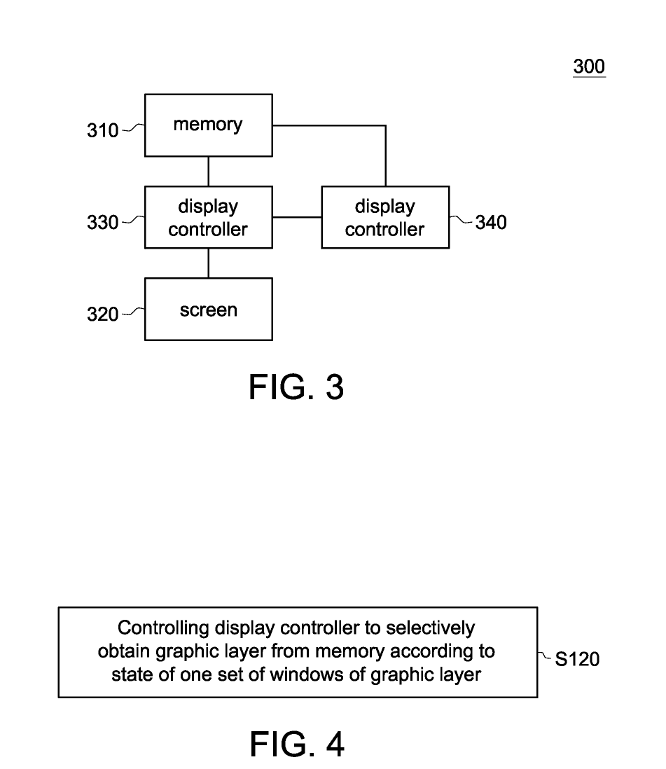

FIG. 3 shows a schematic diagram of another electronic device 300 having a window system. The electronic device 300 includes a memory 310, a screen 320, a display controller 330 and a central operating processor 340. The central operating processor 340 performs various kinds of logic operation processes and logic control processes. For example, the central operating processor 340 is a chip, a circuit board, or a storage medium storing multiple sets of codes.

FIG. 4 shows a flowchart of a control method for the electronic device 300 having a window system. To prevent the graphic layers GL that need not be displayed from occupying the bandwidth between the memory 310 and the display controller 330, in step S120, the central operating processor 340 controls the display controller 330 to selectively obtain a graphic layer GL from the memory 310 according to the state of a set of windows of the graphic layer GL. For example, when all the windows WS that corresponding to one certain graphic layer GL need not be displayed, the central operating processor 340 controls the display controller 330 not to obtain this graphic layer GL from the memory 310, such that the graphic layer GL is not displayed on the screen 320.

In one embodiment, step S120 is triggered in response to a screen update request. For example, a screen update request is generated in response to user operation or an application program updating display information, such as time information or automatically downloaded information.

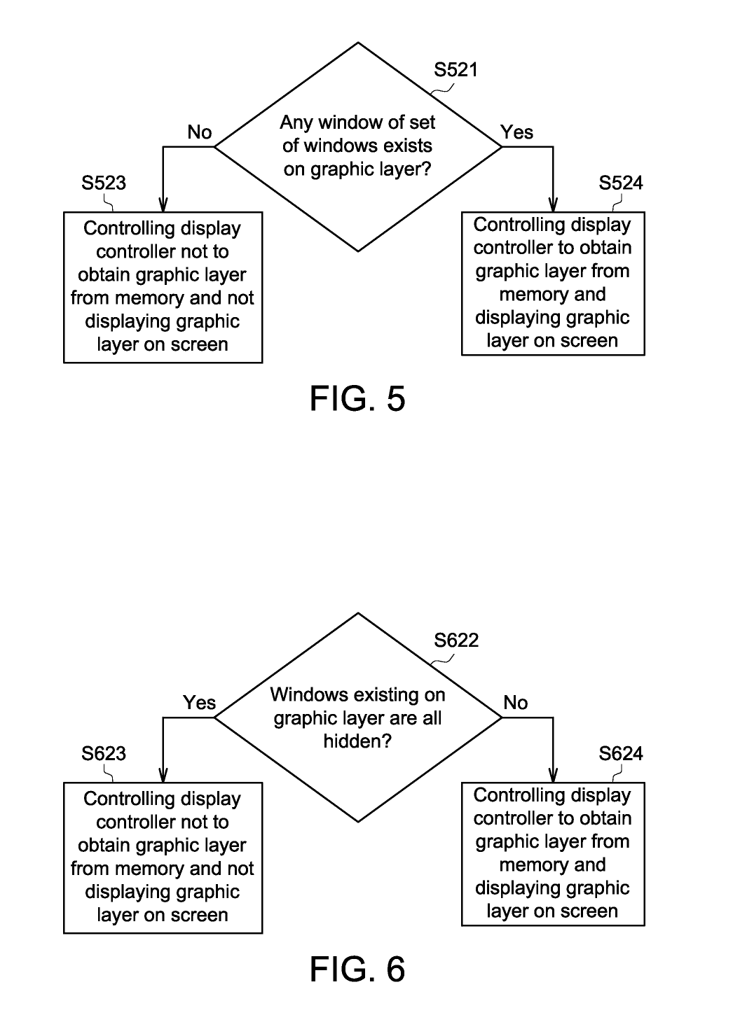

FIG. 5 shows a detailed flowchart of step S120 in FIG. 4. In one embodiment, step S120 includes steps S521, S523 and S524. In step S521, the central operating processor 340 determines whether any window of the set of windows WS corresponding to the graphic layer GL exists on this graphic layer GL. Step S523 is performed when there is not any window of the set of windows WS corresponding to the graphic layer GL exists on this graphic layer GL; otherwise step S524 is performed when there is a window WS of the set of windows WS corresponding to the graphic layer GL exists on this graphic layer GL.

In step S523, the central operating processor 340 controls the display controller 330 not to obtain the graphic layer GL from the memory 310, and thus the graphic layer GL is not displayed on the screen 320. In this step, although the graphic layer GL is not transmitted to the display controller 330, this graphic layer GL remains stored in the memory 310.

In step S524, the central operating processor 340 controls the display controller 330 to obtain the graphic layer GL from the memory 310, and thus the graphic layer GL is displayed on the screen 320.

As such, when there is not any window exists on a graphic layer GL, this graphic layer GL need not be displayed, and the display controller 330 will not obtain the graphic layer GL from the memory 310. Thus, the transmission bandwidth between the display controller 330 and the memory 310 is not occupied by the graphic layer GL.

FIG. 6 shows another detailed flowchart of step S120 in FIG. 4. In another embodiment, step S120 includes steps S622, S623 and S624. In step S622, the central operating processor 340 determines whether all the windows WS existing on the graphic layer GL are hidden. In one example, there are multiple windows WS existing on a graphic layer GL, and some of them may be minimized and thus are hidden. In another example, there are multiple windows WS existing on a graphic layer GL, and some of them may be covered by the other window and thus are hidden.

Step S623 is performed when all the windows WS existing on the graphic layer GL are hidden; otherwise, step S624 is performed when not all the windows WS existing on the graphic layer GL are hidden.

In step S623, the central operating processor 340 controls the display controller 330 not to obtain the graphic layer GL from the memory 310, and thus the graphic layer GL is not displayed on the screen 320.

In step S624, the central operating processor 340 controls the display controller 330 to obtain the graphic layer GL from the memory 310, and thus the graphic layer GL is displayed on the screen 320.

As such, when all the windows WS existing on a graphic layer GL are hidden, this graphic layer GL need not be displayed, and the display controller 330 will not obtain the graphic layer GL from the memory 310. Thus, the transmission bandwidth between the display controller 330 and the memory 310 is not occupied by the graphic layer GL.

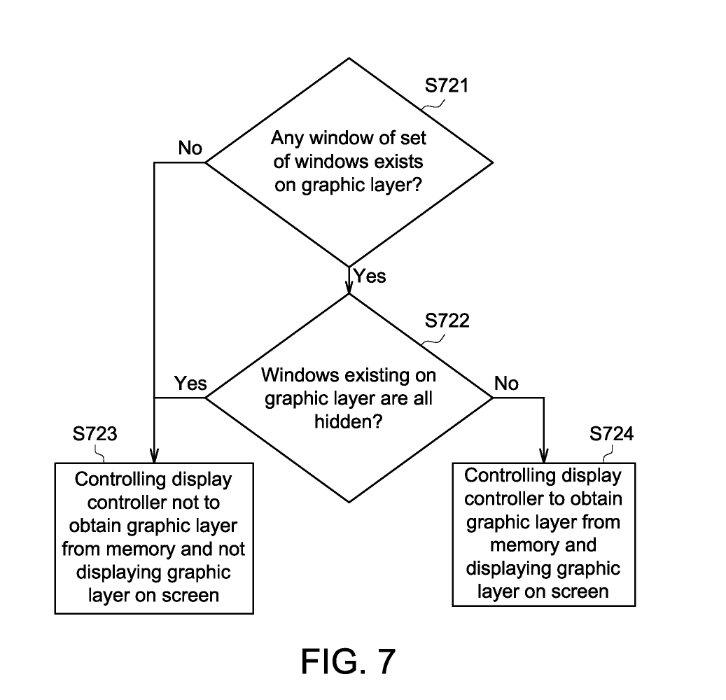

FIG. 7 shows another detailed flowchart of step S120 in FIG. 4. In another embodiment, step S120 includes steps S721, S722, S723 and S724. In step S721, the central operating processor 340 determines whether there is any window of the set of windows WS corresponding to the graphic layer GL existing on the graphic layer GL. Step S723 is performed when there is not any window of the set of window WS existing on the graphic layer GL; otherwise, step S722 is performed when there is a window of the set of window WS existing on the graphic layer GL.

In step S722, the central operating processor 340 determines whether all the windows WS existing on the graphic layer GL are hidden. Step S723 is performed when all the windows WS existing on the graphic layer GL are hidden; otherwise, step S724 is performed when not all the windows WS existing on the graphic layer GL are hidden.

In step S723, the central operating processor 340 controls the display controller 330 not to obtain the graphic layer GL from the memory 310, and thus the graphic layer GL is not displayed on the screen 320.

In step S724, the central operating processor 340 controls the display controller 330 to obtain the graphic layer GL from the memory 310, and thus the graphic layer GL is displayed on the screen 320.

As such, when there is not any window WS existing on the graphic layer GL, or when all the windows WS existing on the graphic layer GL are hidden, this graphic layer GL need not be displayed, and the display controller 330 will not obtain the graphic layer GL from the memory 310. Thus, the transmission bandwidth between the display controller 330 and the memory 310 is not occupied by the graphic layer GL.

The above control method describes a control method for one single graphic layer GL. When the electronic device 300 has multiple graphic layers GL, the central operating processor 340 independently performs the above determination and control processes for individual graphic layers GL.

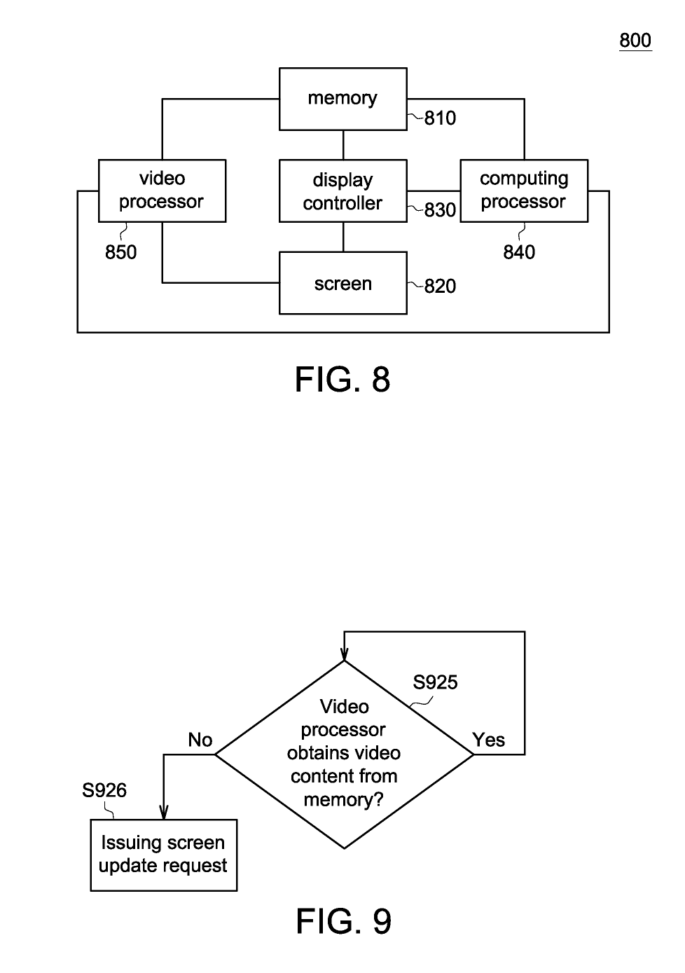

FIG. 8 shows a schematic diagram of another electronic device 800 having a window system. In another embodiment, the electronic device 800 includes a memory 810, a screen 820, a display controller 830, a central operating processor 840 and a video processor 850. For example, the electronic device 800 is a smart television. The video processor 850 decompressed video contents to allow the video contents to be played on the screen 820. For example, the video processor 850 is a chip, a circuit board, or a storage medium storing multiple sets of codes.

In the embodiment, when the central operating processor 840 controls the display controller 830 not to obtain the graphic layer GL from the memory 810, as the above steps S523, S623 and S723, the video processor 850 could receive video contents from the memory 810 to accordingly display the video contents on the screen 820.

FIG. 9 shows another flowchart of a control method for the electronic device 800. When the central operating processor 830 controls the display controller 830 not to obtain the graphic layer GL from the memory 810, the control method for the electronic device 800 may further include steps S925 and S926.

In step S925, the central operating processor 840 determines whether the video processor 850 obtains video contents from the memory 810. Step S926 is performed when the video processor 850 does not obtain the video contents from the memory 810.

In step S926, the central operating processor 840 issues a screen update request. For example, the screen update request is for displaying a display message of “no signal”. After issuing the screen update request, the step of selectively controlling the display controller 810 to obtain the graphic layer GL is triggered in response to the screen update request.

Through the embodiments, the display controllers 130, 330 and 830 do not obtain the graphic layer GL that need not be displayed from the memories 110, 310 and 810, and thus the load of transmission bandwidth between the display controllers 130, 330 and 830 and the memories 110, 310 and 810 is reduced.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A control method for an electronic device having a window system, the electronic device comprising a memory, a display controller and a screen, the control method comprising:
storing a graphic layer to the memory, the graphic layer comprising a set of windows;
controlling the display controller to selectively obtain the graphic layer from the memory according to a state of the set of windows of the graphic layer; and
displaying the graphic layer on the screen when the graphic layer is obtained by the display controller.

2. The control method according to claim 1, wherein the step of controlling the display controller to selectively obtain the graphic layer from the memory according to the state of the set of windows of the graphic layer comprises:
controlling the display controller to selectively obtain the graphic layer from the memory according to whether there is any window of the set of windows existing on the graphic layer.

3. The control method according to claim 2, wherein the step of controlling the display controller to selectively obtain the graphic layer from the memory according to whether there is any window of the set of windows existing on the graphic layer comprises:
determining whether there is any window of the set of windows existing on the graphic layer; and
controlling the display controller not to obtain the graphic layer from the memory when it is determined that there is not any window of the set of windows existing on the graphic layer, and thus the graphic layer is not displayed on the screen.

4. The control method according to claim 3, wherein the step of controlling the display controller to selectively obtain the graphic layer from the memory according to whether there is any window of the set of windows existing on the graphic layer further comprises:
controlling the display controller to obtain the graphic layer from the memory when it is determined that at least one window of the set of windows existing on the graphic layer, and thus the graphic layer is displayed on the screen.

5. The control method according to claim 3, wherein the step of controlling the display controller to selectively obtain the graphic layer from the memory according to whether there is any window of the set of windows existing on the graphic layer further comprises:
when it is determined that at least one window of the set of windows exists on the graphic layer, controlling the display controller to selectively obtain the graphic layer from the memory according to a hidden state of the at least one window existing on the graphic layer.

6. The control method according to claim 5, wherein the step of controlling the display controller to selectively obtain the graphic layer from the memory according to the hidden state of the at least one window existing on the graphic layer comprises:
determining whether all of the at least one window existing on the graphic layer is hidden; and
controlling the display controller not to obtain the graphic layer from the memory when all of the at least one window existing on the graphic layer is hidden, and thus the graphic layer is not displayed on the screen.

7. The control method according to claim 1, wherein the step of controlling the display controller to selectively obtain the graphic layer from the memory according to the state of the set of windows of the graphic layer comprises:
controlling the display controller to selectively obtain the graphic layer from the memory according to a hidden state of at least one window of the set of windows existing on the graphic layer.

8. The control method according to claim 7, wherein the step of controlling the display controller to selectively obtain the graphic layer from the memory according to the hidden state of the at least one window of the set of windows existing on the graphic layer comprises:
determining whether all of the at least one window existing on the graphic layer is hidden; and
controlling the display controller not to obtain the graphic layer from the memory when it is determined that all of the at least one window existing on the graphic layer is hidden, and thus the graphic layer is not displayed on the screen.

9. The control method according to claim 1, wherein the step of controlling the display controller to selectively obtain the graphic layer from the memory according to the state of the set of windows of the graphic layer is triggered in response to a screen update request.

10. The control method according to claim 9, wherein the electronic device further comprises a video processor, the video processor is configured to obtain a video content from the memory to display the video content on the screen, the control method further comprising:
when controlling the display controller not to obtain the graphic layer from the memory according to the state of the set of windows of the graphic layer, determining whether to issue the screen update request according to whether the video processor obtains the video content from the memory.

11. The control method according to claim 10, wherein the step of determining whether to issue the screen update request according to whether the video processor obtains the video content from the memory comprises:
determining whether the video processor obtains the video content from the memory; and
issuing the screen update request when it is determined that the video processor does not obtain the video content from the memory.

12. An electronic device having a window system, comprising:
a screen;
a display controller;
a memory, configured to store a graphic layer, the graphic layer comprising a set of windows; and
a central operating processor, configured to control the display controller to selectively obtain the graphic layer from the memory according to a state of the set of windows of the graphic layer;
wherein, when the display controller obtains the graphic layer, the graphic layer is displayed on the screen.

13. The electronic device according to claim 12, wherein the central operating processor controls the display controller to selectively obtain the graphic layer from the memory according to whether there is any window of the set of windows exists on the graphic layer.

14. The electronic device according to claim 13, wherein when the central operating processor determines that there is not any window of the set of windows exists on the graphic layer, the central operating processor controls the display controller not to obtain the graphic layer from the memory, and thus the graphic layer is not displayed on the screen.

15. The electronic device according to claim 14, wherein when the central operating processor determines that there is at least one window of the set of windows exists on the graphic layer, the central operating processor controls the display controller to obtain the graphic layer from the memory, and thus the graphic layer is displayed on the screen.

16. The electronic device according to claim 14, wherein when the central operating processor determines that there is at least one window of the set of windows exists on the graphic layer, the central operating processor selectively controls the display controller to obtain the graphic layer from the memory according to a hidden state of the at least one window existing on the graphic layer.

17. The electronic device according to claim 16, wherein when the central operating processor determines that all of the at least one window present on the graphic layer is hidden, the central operating processor controls the display controller not to obtain the graphic layer from the memory, and thus the graphic layer is not displayed on the screen.

18. The electronic device according to claim 12, wherein the central operating processor controls the display controller to selectively obtain the graphic layer from the memory according to a hidden state of the at least one window of the set of windows existing on the graphic layer.

19. The electronic device according to claim 18, wherein when the central operating processor determines that all of the at least one window existing on the graphic layer is hidden, the central operating processor controls the display controller not to obtain the graphic layer from the memory, and thus the graphic layer is not displayed on the screen.

20. The electronic device according to claim 12, wherein the central operating processor controls the display controller to selectively obtain the graphic layer from the memory according to the state of the set of windows of the graphic layer in response to a screen update request.

21. The electronic device according to claim 20, further comprising:
a video processor, configured to obtain a video content from the memory to display the video content on the screen;
wherein, when the display controller does not obtain the graphic layer from the memory, the central operating processor determines whether to issue the screen update request according to whether the video processor obtains the video content from the memory.

22. The electronic device according to claim 21, wherein when the central operating processor determines that the video processor does not obtain the video content from the memory, the central operating processor issues the screen update request.
